(19) United States
(12) Patent Application Publication
(10) Pub. No.: US 2008/0184352 A1
(43) Pub. Date: Jul. 31, 2008

(54) Information processing apparatus, authentication system, authentication method, and authentication program using biometric information for authentication

(75) Inventor: Tomohiro Nishiguchi, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/010,430

(22) Filed: Jan. 24, 2008

(30) Foreign Application Priority Data
Jan. 31, 2007 (JP) 2007-020687

(51) Int. Cl. G06F 21/20

(52) U.S. Cl. 726/7

(57) ABSTRACT

In order to simplify the operation and lower the misidentification rate, the MFP includes an HDD to store a temporary record including a fingerprint image of a user and user identification information, a fingerprint image accepting portion to accept a fingerprint image of a user, an extracting portion to extract one of the temporary records stored in the HDD that includes a fingerprint image matching the accepted fingerprint image as a target record, a first requesting portion, when the target record is extracted, to transmit an authentication request, including the user identification information included in the target record and the fingerprint image, to an authentication server, and a permission portion to permit login of the user having the accepted fingerprint image, based on an authentication result received from the authentication server in response to transmission of the authentication request.

This application is based on Japanese Patent Application No. 2007-20687 filed with Japan Patent Office on Jan. 31, 2007, the entire content of which is hereby incorporated by reference.

### BACKGROUND OF THE INVENTION

1. Field of the Invention

The present invention relates to an information processing apparatus, an authentication system, an authentication method, and an authentication program, and more particularly to an information processing apparatus, an authentication system, an authentication method, and an authentication program that use biometric information for authentication.

2. Description of the Related Art

In recent years, there is known a biometric authentication technique which uses a human fingerprint for authentication to identify a user as disclosed in Japanese Patent Laid-Open No. 2000-276018, for example. With the fingerprint authentication, as the number of fingerprints for authentication increases, the number of similar fingerprints increases, which may lead to degradation in accuracy of authentication and prolonged processing time for the authentication.

There is also known an authentication technique which prompts input of a user ID and a fingerprint, and compares the input fingerprint with the fingerprint prestored in association with the input user ID, as disclosed, e.g., in Japanese Patent Laid-Open No. 2006-202207. With this conventional authentication technique, pattern matching is required only once, which improves the accuracy of authentication and reduce the processing time for the authentication. The user, however, needs to input both the user ID and the fingerprint, which requires troublesome operations. As such, in the fingerprint authentication, if a higher priority is set on the convenience in operation, the misidentification rate would increase, whereas the attempt to lower the misidentification rate would impair the convenience in operation.

### SUMMARY OF THE INVENTION

The present invention has been accomplished in view of the foregoing problems, and an object of the present invention is to provide an information processing apparatus capable of simplifying the operation and at the same time lowering the misidentification rate.

Another object of the present invention is to provide an authentication system capable of simplifying the operation and also lowering the misidentification rate.

A further object of the present invention is to provide an authentication method capable of simplifying the operation and also lowering the misidentification rate.

Yet another object of the present invention is to provide an authentication program capable of simplifying the operation and also lowering the misidentification rate.

In order to achieve the above objects, according to an aspect of the present invention, there is provided an information processing apparatus which includes: a storage portion to store a temporary record including biometric information of a user and user identification information; a biometric information accepting portion to accept biometric information of a user; an extracting portion to extract a target record including biometric information matching the accepted biometric information from among the temporary records stored in the storage portion; a requesting portion, when the target record is extracted by the extracting portion, to transmit an authentication request to an authentication server, the authentication request including the user identification information included in the target record and the biometric information; and a permission portion to permit login of the user having the biometric information accepted by the biometric information accepting portion, based on an authentication result received from the authentication server in response to transmission of the authentication request by the requesting portion.

According to another aspect of the present invention, there is provided an information processing apparatus which includes: a biometric information accepting portion to accept biometric information of a user; an identification information accepting portion to accept user identification information; a requesting portion to transmit an authentication request to an authentication server, the authentication request including the accepted biometric information and the accepted user identification information; and a registration portion to register a temporary record including the accepted biometric information and the accepted user identification information, based on an authentication result received from the authentication server in response to transmission of the authentication request by the requesting portion.

According to yet another aspect of the present invention, there is provided an authentication system having a plurality of information processing apparatuses and an authentication server, wherein each of the plurality of information processing apparatuses includes: a storage portion to store a temporary record including biometric information of a user and user identification information; a biometric information accepting portion to accept biometric information of a user; an extracting portion to extract a target record including biometric information matching the accepted biometric information from among the temporary records stored in the storage portion; a requesting portion, when the target record is extracted by the extracting portion, to transmit an authentication request to an authentication server, the authentication request including the user identification information included in the target record and the biometric information; and a permission portion to permit login of the user having the biometric information accepted by the biometric information accepting portion, based on an authentication result received from the authentication server in response to transmission of the authentication request by the requesting portion; and wherein the authentication server includes: a registration record storage portion to store a plurality of registration records each including biometric information of a user and user identification information; an authentication record extracting portion, in response to reception of the authentication request from one of the plurality of information processing apparatuses, to extract a record for authentication including user identification information identical to the user identification information included in the received authentication request from among the plurality of registration records stored in the registration record storage portion; a comparison portion to compare biometric information included in the record for authentication with the biometric information included in the authentication request; and an authentication result transmitting portion to transmit a comparison result by the comparison portion to the one of the plurality of information processing apparatus that transmitted the authentication request.

According to a further aspect of the present invention, there is provided an authentication method including the steps of: storing a temporary record including biometric information of a user and user identification information; accepting biometric information of a user; extracting a target record including biometric information matching the accepted biometric information from among the temporary records stored; when the target record is extracted by the step of extracting the target record, transmitting an authentication request to an authentication server, the authentication request including the user identification information included in the target record and the biometric information; and permitting login of the user having the biometric information accepted in the step of accepting the biometric information, based on an authentication result received from the authentication server in response to transmission of the authentication request.

According to a still further aspect of the present invention, there is provided an authentication method executed by a plurality of information processing apparatuses and an authentication server, wherein the method causes each of the plurality of information processing apparatuses to execute the steps of: storing a temporary record including biometric information of a user and user identification information; accepting biometric information of a user; extracting a target record including biometric information matching the accepted biometric information from among the temporary records stored; when the target record is extracted, transmitting an authentication request to an authentication server, the authentication request including the user identification information included in the target record and the biometric information; and permitting login of the user having the biometric information accepted in the step of accepting the biometric information, based on an authentication result received from the authentication server in response to transmission of the authentication request; and wherein the method causes the authentication server to execute the steps of: storing a plurality of registration records each including biometric information of a user and user identification information; in response to reception of the authentication request from one of the plurality of information processing apparatuses, extracting a record for authentication including user identification information identical to the user identification information included in the received authentication request from among the plurality of registration records stored; comparing biometric information included in the record for authentication with the biometric information included in the authentication request; and transmitting a comparison result in the comparing step to the one of the plurality of information processing apparatuses that transmitted the authentication request.

According to yet another aspect of the present invention, there is provided an authentication program embodied on a computer readable medium for causing a computer to execute processing including the steps of: storing a temporary record including biometric information of a user and user identification information; accepting biometric information of a user; extracting a target record including biometric information matching the accepted biometric information from among the temporary records stored; when the target record is extracted by the step of extracting the target record, transmitting an authentication request to an authentication server, the authentication request including the user identification information included in the target record and the biometric information; and permitting login of the user having the biometric information accepted in the step of accepting the biometric information, based on an authentication result received from the authentication server in response to transmission of the authentication request.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of an authentication system according to an embodiment of the present invention.

FIG. 2 shows an example of the hardware configuration of an authentication server.

FIG. 3 is a perspective view of an MFP.

FIG. 4 is a block diagram showing an example of the circuit configuration of the MFP.

FIG. 5 is a functional block diagram showing an example of the function of a CPU provided in the authentication server together with data stored in an HDD.

FIG. 6 shows an example of the format of a registration record.

FIG. 7 is a flowchart illustrating an example of the flow of user registration processing.

FIG. 8 is a flowchart illustrating an example of the flow of authentication processing.

FIG. 9 is a functional block diagram schematically showing the function of a CPU provided in the MFP together with data stored in an HDD.

FIG. 10 is a plan view showing an example of an operation panel on which an authentication screen is displayed.

FIG. 11 is a plan view showing an example of the operation panel on which an identification information input screen is displayed.

FIG. 12 shows an example of the format of a temporary record.

FIG. 13 is a flowchart illustrating an example of the flow of authentication accepting processing executed in the MFP.

FIG. 14 is a flowchart illustrating an example of the flow of temporary record registration processing.

FIG. 15 is a flowchart illustrating an example of the flow of initialization processing.

### DESCRIPTION OF THE PREFERRED EMBODIMENTS

Hereinafter, embodiments of the present invention will be described with reference to the drawings. In the following description, like reference characters denote like parts, which have like names and functions, and therefore, detailed description thereof will not be repeated.

FIG. 1 is a schematic diagram of an authentication system according to an embodiment of the present invention. Referring to FIG. 1, an authentication system 1 includes multi-function peripherals (MFPs) 100, 100A, 100B, and 100C, and an authentication server 200, which are connected to a network 2.

MFPs 100, 100A, 100B, and 100C are examples of the information processing apparatus. They are identical in hardware configuration and function, and thus, MFP 100 is herein explained representatively. Authentication server 200, which is a common computer, has an authentication function for authentication of users, and is responsible for authentication of the users of MFPs 100, 100A, 100B, and 100C. MFPs 100, 100A, 100B, and 100C and authentication server 200 are connected to each other via network 2, which enables communication therebetween.

Network 2 is a local area network (LAN), which may be wired or wireless. However, not restricted thereto, network 2 may be a wide area network (WAN), a network using public line, or the like.

While authentication system 1 includes authentication server 200 and four MFPs 100, 100A, 100B, and 100C in this example, their numbers are not limited thereto. All that is needed is that the system includes one authentication server 200 and at least one MFP.

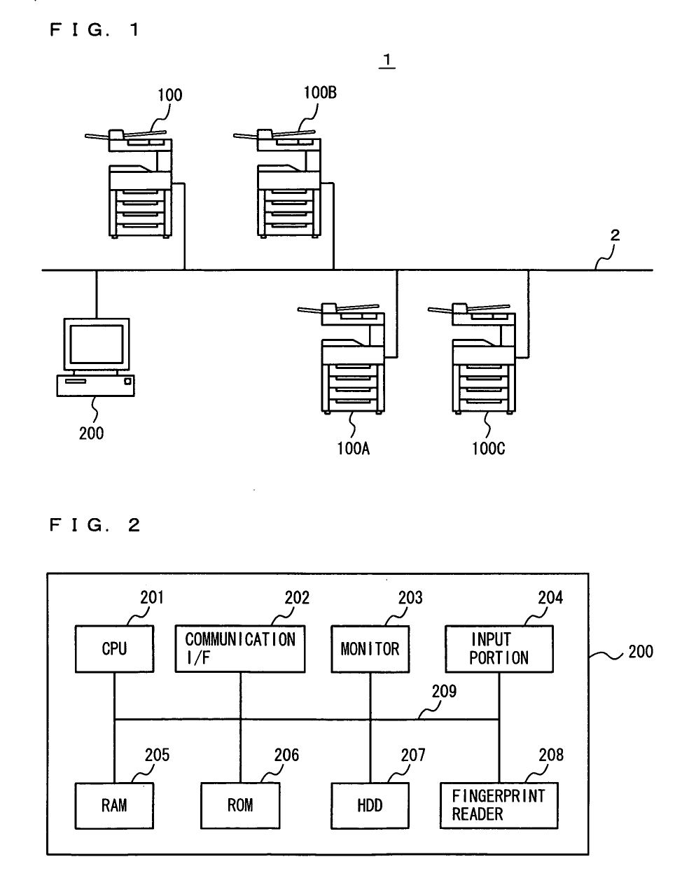

FIG. 2 shows an example of the hardware configuration of the authentication server. Referring to FIG. 2, authentication server 200 includes a central processing unit (CPU) 201, a random access memory (RAM) 205 used as a working area for CPU 201, a read only memory (ROM) 206 for storing a program to be executed by CPU 201, a hard disk drive (HDD) 207, a communication interface (I/F) 202 for connecting authentication server 200 to network 2, an input portion 204 provided with a keyboard, mouse and the like, a monitor 203 for displaying information, and a fingerprint reader 208.

Fingerprint reader 208 includes a photoelectric conversion element such as a charge coupled device (CCD), and reads a fingerprint of the user of MFP 100 and outputs a fingerprint image to CPU 201.

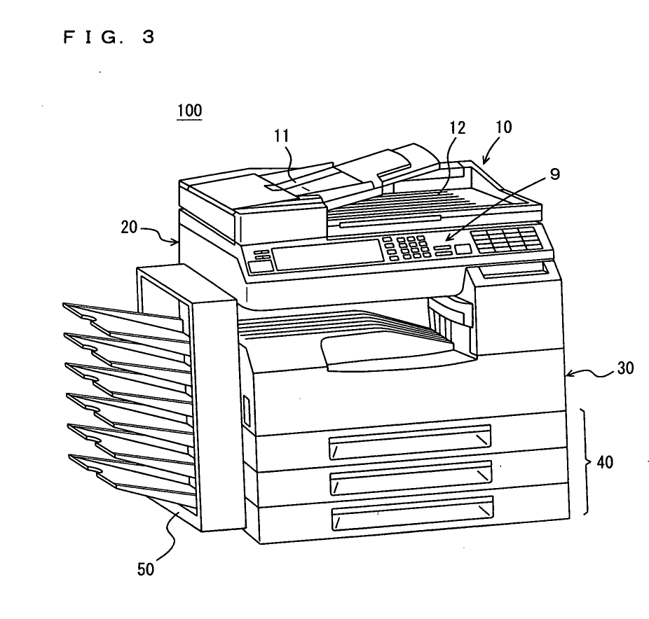

FIG. 3 is a perspective view of the MFP. Referring to FIG. 3, MFP 100 includes an automatic document feeder (ADF) 10, an image reading portion 20, an image forming portion 30, a paper feeding portion 40, and a post processing portion 50.

ADF 10 automatically delivers a plurality of originals, set on an original feed tray 11, one by one to a predetermined original reading position on a platen glass of image reading portion 20, and discharges the original having its original image read by image reading portion 20 onto an original discharge tray 12. Image reading portion 20 includes a light source that irradiates the original delivered to the original reading position with light, and a photoelectric conversion element that receives the light reflected from the original, and scans the original image in accordance with the original size. The photoelectric conversion element converts the received light into image data of electric signals, and outputs the same to image forming portion 30. Paper feeding portion 40 delivers sheets of paper stored in a paper feed tray to image forming portion 30.

Image forming portion 30 forms an image by well-known electrophotography. It performs various data processing including shading compensation on the image data input from image reading portion 20, and, based on the processed image data, forms an image on a sheet of paper fed by paper feeding portion 40.

Post processing portion 50 discharges the recording sheet on which the image was formed. Post processing portion 50 has a plurality of paper discharge trays to allow sorting of the sheets having the images formed thereon for discharge. Post processing portion 50 also has a punching portion and a stapling portion to allow the discharged sheets to be punched or stapled. MFP 100 also includes an operation panel 9 on a top surface thereof, which serves as a user interface with the user.

While MFPs 100, 100A, 100B, and 100C are shown as the examples of the information processing apparatus in the present embodiment, the information processing apparatus may be any apparatus, besides the MFPs, as long as it can restrict the user(s) to whom the use is authorized, such as a scanner, a printer, a facsimile, a personal computer, or the like.

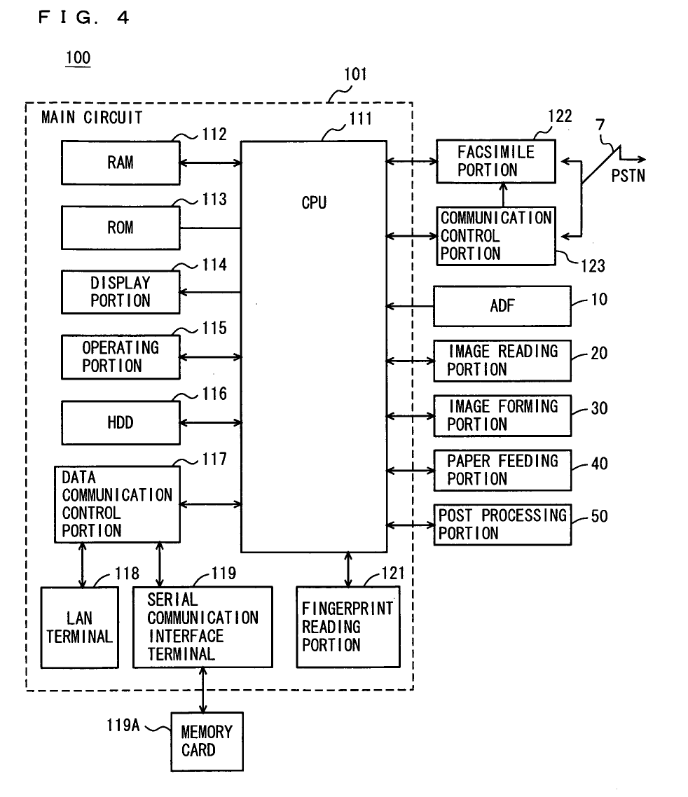

FIG. 4 is a block diagram showing an example of the circuit configuration of the MFP. Referring to FIG. 4, MFP 100 includes a main circuit 101, a facsimile portion 122, and a communication control portion 123. Main circuit 101 is connected to ADF 10, image reading portion 20, image forming portion 30, paper feeding portion 40, and post processing portion 50.

Main circuit 101 includes a CPU 111, a RAM 112 used as a working area for CPU 111, a ROM 113 for storing a program executed by CPU 111 and the like, a display portion 114, an operating portion 115, an HDD 116 as a mass storage, a data communication control portion 117, and a fingerprint reading portion 121.

CPU 111 is connected with display portion 114, operating portion 115, HDD 116, data communication control portion 117, and fingerprint reading portion 121, and is responsible for overall control of main circuit 101. CPU 111 is also connected with facsimile portion 122, communication control portion 123, ADF 10, image reading portion 20, image forming portion 30, paper feeding portion 40, and post processing portion 50, and is responsible for overall control of MFP 100.

Display portion 114 is a display device such as a liquid crystal display (LCD), an organic electro-luminescence display (ELD) or the like, and displays an instruction menu for the user, information about acquired image data, and others. Operating portion 115 is provided with a plurality of keys, and accepts input of data such as instructions, characters and numerical characters, according to the key operations of the user. Operating portion 115 includes a touch panel provided on display portion 114. Fingerprint reading portion 121 includes a photoelectric conversion element such as a CCD, and reads a fingerprint of the user of MFP 100 and outputs the fingerprint image to CPU 111. Display portion 114, operating portion 115 and fingerprint reading portion 121 constitute operation panel 9 provided on the top surface of MFP 100.

Data communication control portion 117 includes a LAN terminal 118 that is an interface for communication according to a communication protocol such as TCP (Transmission Control Protocol) or FTP (File Transfer Protocol), and a serial communication interface terminal 119 for serial communication. Data communication control portion 117 transmits and receives data to and from an external apparatus connected to LAN terminal 118 or serial communication interface terminal 119, in accordance with an instruction from CPU 111.

When a LAN cable for connection to network 2 is connected to LAN terminal 118, data communication control portion 117 communicates with another MFP or computer connected via LAN terminal 118. Data communication control portion 117 also communicates with another computer connected to the Internet.

When an apparatus is connected to serial communication interface terminal 119, data communication control portion 117 communicates with the apparatus connected to serial communication interface terminal 119, which may be, e.g., a digital camera, a digital video camera, or a personal digital assistant, to input/output image data. A memory card 119A having a flash memory built therein can also be connected to serial communication interface terminal 119. CPU 111 controls data communication control portion 117 to read an authentication program to be executed by CPU 111 from memory card 119A, and stores the read authentication program in RAM 112 for execution.

It is noted that the recording medium for storing the authentication program to be executed by CPU 111 is not restricted to memory card 119A. It may be a flexible disk, a cassette tape, an optical disc (CD-ROM (Compact Disc-ROM), MO (Magnetic Optical Disc), MD (Mini Disc), DVD (Digital Versatile Disc)), an IC card (including a memory card), an optical card, or a semiconductor memory such as a masked ROM, an EPROM (Erasable Programmable ROM), an EEPROM (Electronically EPROM), or the like. Alternatively, CPU 111 may download the authentication program from a computer connected to the Internet and store the same in HDD 116, or a computer connected to the Internet may write the authentication program to HDD 116, and thereafter, the authentication program stored in HDD 116 may be loaded to RAM 112 for execution by CPU 111. As used herein, the “program” includes, not only the program directly executable by CPU 111, but also a source program, a compressed program, an encrypted program, and others.

Communication control portion 123 is a modem for connecting CPU 111 to a public switched telephone network (PSTN) 7. MFP 100 is assigned a telephone number in PSTN 7 in advance. When there is a call from a facsimile machine connected to PSTN 7 to the telephone number assigned to MFP 100, communication control portion 123 detects the call. Upon detection of the call, communication control portion 123 establishes the call to enable communication of facsimile portion 122.

Facsimile portion 122 is connected to PSTN 7, and transmits facsimile data to or receives facsimile data from PSTN 7.

FIG. 5 is a functional block diagram showing an example of the function of CPU 201 provided in authentication server 200, together with data stored in HDD 207. Referring to FIG. 5, CPU 201 provided in authentication server 200 includes: a user registration portion 81 for registration of a user as a target of authentication; a request receiving portion 83 to receive an authentication request from any of MFPs 100, 100A, 100B, and 100C; a registration record extracting portion 85 to extract a registration record according to the authentication request; a comparison portion 87 to compare two pieces of biometric information; and an authentication result transmitting portion 89 to transmit an authentication result, based on the comparison result, to the apparatus that transmitted the authentication request.

For registration of a user to be authenticated, user registration portion 81 stores a registration record 91 corresponding to the user in HDD 207. User registration portion 81 accepts user identification information and a fingerprint image of the user, generates a registration record 91 including the user identification information and the fingerprint image, and stores the generated registration record in HDD 207.

When the user inputs the user identification information to input portion 204, user registration portion 81 receives it from input portion 204. When the user causes fingerprint reader 208 to read the fingerprint, user registration portion 81 receives the fingerprint image from fingerprint reader 208. When user registration portion 81 registers a plurality of users, a plurality of registration records 91 corresponding to the respective users are stored in HDD 207.

User registration portion 81 stores the registration record in HDD 207 on the condition that an administrator of authentication server 200 is authenticated. This is for the purpose of registering only the users authenticated by the administrator. For example, when authentication server 200 is used, login is requested, and the registration record is stored in HDD 207 only in the case where the login is allowed. Alternatively, it may be configured such that registration record 91 is stored on the condition that a predetermined password is input. In this case, registration can be made only by the user as a target of registration, even if the administrator has not logged in. The registration records are stored for the users who know the password, which makes it possible to register only the specific users.

While the case of inputting a fingerprint image from fingerprint reader 208 has been described above, alternatively, a fingerprint image that was obtained when the user caused another fingerprint reader to read his/her fingerprint may be received from another computer, or still alternatively, a fingerprint image stored in a recording medium such as a semiconductor memory may be read out. In these cases, the user to be registered does not need to operate the authentication server, because the administrator alone can register the user.

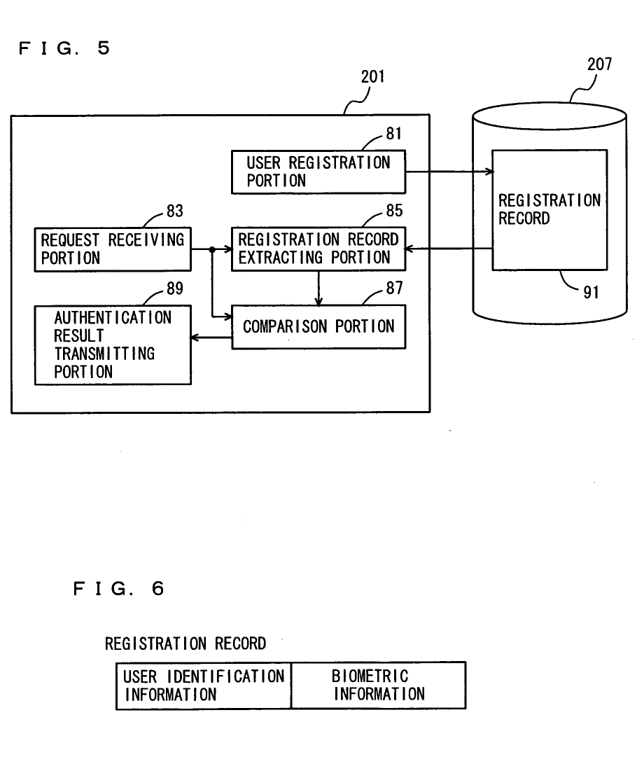

FIG. 6 shows an example of the format of the registration record. Referring to FIG. 6, the registration record has user identification information for identification of a user and biometric information unique to the user, which are associated with each other. The user identification information is a user ID, which may be, for example, a symbol, a character, a numerical character, or a combination thereof, assigned to the user. The biometric information is fingerprint, iris, vein pattern, or the like. Herein, a fingerprint image obtained by picking up the fingerprint is used as the biometric information. Although the registration record may include the fingerprint image itself, it may instead include a file name for identifying the data file of the fingerprint image, or may include a pointer to the data file.

Request receiving portion 83 receives an authentication request from one of MFPs 100, 100A, 100B, and 100C. When communication I/F 202 receives an authentication request from one of MFPs 100, 100A, 100B, and 100C, request receiving portion 83 receives the authentication request from communication I/F 202. The authentication request includes the user identification information and the biometric information. Herein, provided that the authentication request is received from MFP 100, the user identification information is the one for identifying the user who is trying to log in MFP 100, and the biometric information is the fingerprint image obtained by reading the fingerprint of the relevant user. Request receiving portion 83 outputs the authentication request to registration record extracting portion 85 and to comparison portion 87.

Further, request receiving portion 83 acquires apparatus identification information for identification of MFP 100 that transmitted the authentication request. This is for the purpose of transmitting to MFP 100 an authentication result, which will be described later. Herein, the position information on network 2 assigned to MFP 100 is acquired, which may be, for example, an IP (Internet Protocol) address or a MAC (Media Access Control) address.

Registration record extracting portion 85 extracts, from among registration records 91 stored in HDD 207, a registration record including the user identification information the same as the one included in the authentication request, as a record for authentication. When registration record extracting portion 85 succeeded in extracting the registration record including the user identification information the same as the one included in the authentication request, it outputs the relevant registration record 91 as the record for authentication to comparison portion 87. If it failed to extract the record, it outputs an error signal indicating that it failed to extract the record to comparison portion 87.

When receiving the record for authentication from registration record extracting portion 85, comparison portion 87 compares the biometric information included in the record for authentication with the biometric information included in the authentication request. If they match as a result of comparison, it outputs a success signal to authentication result transmitting portion 89, whereas if they do not match, it outputs a failure signal to authentication result transmitting portion 89. When the error signal is input from registration record extracting portion 85, comparison portion 87 outputs a failure signal to authentication result transmitting portion 89. Herein, it is determined that there is a match between the biometric information not only in the case where they match completely but also in the case where they are similar enough to be determined to be of a same person.

Authentication result transmitting portion 89, when receiving a success signal from comparison portion 87, transmits an authentication result indicating authentication success to the apparatus identified by the apparatus identification information acquired by request receiving portion 83, i.e., MFP 100 in this case. When receiving a failure signal from comparison portion 87, authentication result transmitting portion 89 transmits an authentication result indicating authentication failure to MFP 100.

Authentication server 200 needs to compare the biometric information only once for one authentication request, which reduces the time required from the time when the authentication request was received to the time when the authentication result is returned, and also improves the accuracy of authentication.

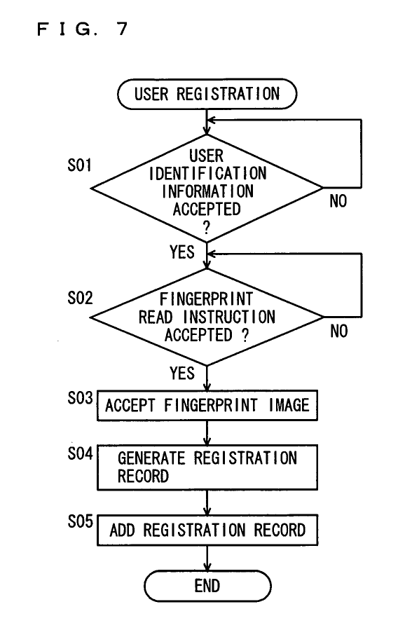

FIG. 7 is a flowchart illustrating an example of the flow of user registration processing. The user registration processing is carried out by CPU 201 provided in authentication server 200 as CPU 201 executes the authentication program. Referring to FIG. 7, CPU 201 determines whether user identification information has been accepted (step S01). When the user inputs the user identification information using a keyboard or the like of input portion 204, input portion 204 accepts the user identification information. CPU 201 is in a standby mode until the user identification information is accepted (NO in step S01), and once the user identification information is accepted (YES in step S01), the process proceeds to step S02.

In step S02, it is determined whether a fingerprint read instruction to cause fingerprint reading has been accepted. Specifically, it is determined whether a predetermined key has been depressed on the keyboard of input portion 204 to cause fingerprint reader 208 to read a fingerprint. CPU 201 is in a standby mode until the fingerprint read instruction is accepted (NO in step S02), and once the fingerprint read instruction is accepted (YES in step S02), the process proceeds to step S03.

In step S03, the fingerprint image output from fingerprint reading portion 121 is accepted. A registration record is generated (step S04). The registration record includes the user identification information accepted in step S01 and the fingerprint image accepted in step S03. In the following step S05, the generated registration record is additionally stored in HDD 207, and the process is terminated.

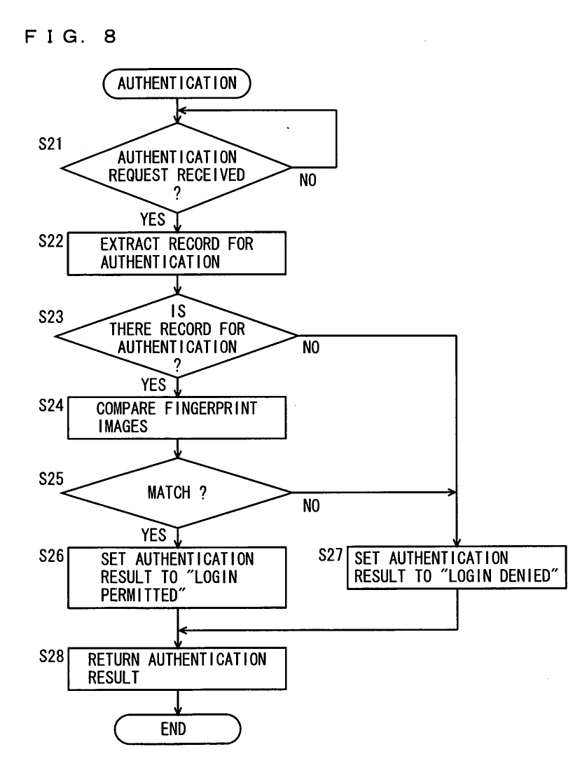

FIG. 8 is a flowchart illustrating an example of the flow of authentication processing. The authentication processing is carried out by CPU 201 of authentication server 200 as CPU 201 executes the authentication program. Referring to FIG. 8, CPU 201 is in a standby mode until an authentication request is received from one of MFPs 100, 100A, 100B, and 100C (NO in step S21), and once the authentication request is received (YES in step S21), the process proceeds to step S22. In other words, the authentication processing is the processing that is carried out on the condition that the authentication request is received from one of MFPs 100, 100A, 100B, and 100C.

In step S22, a registration record including the user identification information the same as the one included in the authentication request received in step S21 is extracted from among registration records 91 stored in HDD 207, as a record for authentication.

In step S23, it is determined whether the record for authentication has been extracted. If so, the process proceeds to step S24; otherwise, the process proceeds to step S27. In step S24, comparison is made between the biometric information (fingerprint image) included in the extracted record for authentication and the fingerprint image included in the authentication request received in step S21.

In step S25, it is determined whether they match as a result of comparison. If they match, the process proceeds to step S26, while if not, the process proceeds to step S27. In step S26, the authentication result is set to “login permitted”, indicating authentication success, and the process proceeds to step S28. In step S27, the authentication result is set to “login denied”, indicating authentication failure, and the process proceeds to step S28. In step S28, the authentication result is returned to the one of MFPs 100, 100A, 100B, and 100C that transmitted the authentication request received in step S21. The process is then terminated.

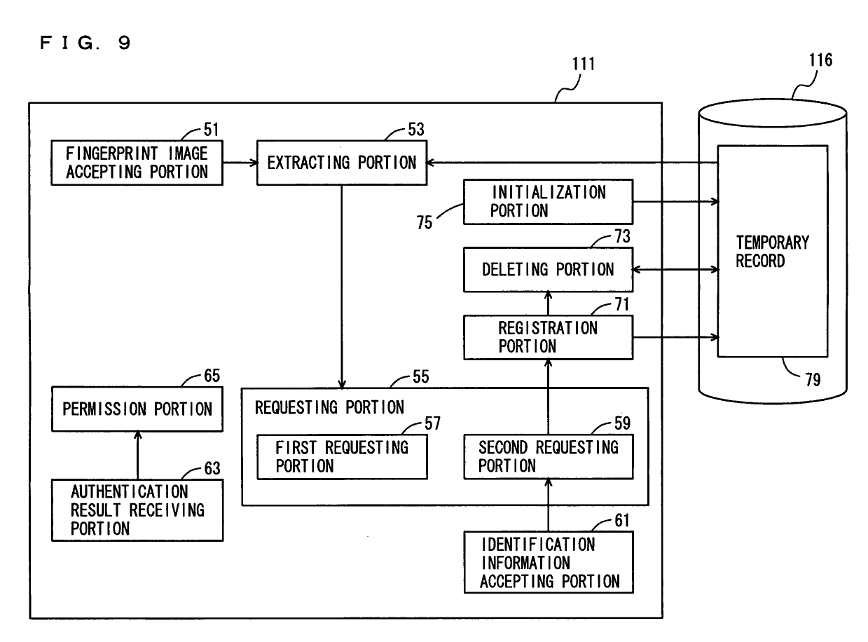

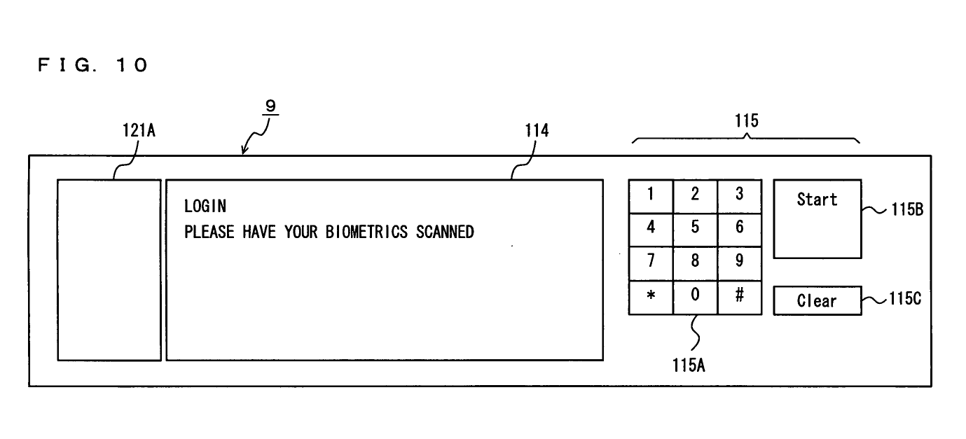

FIG. 9 is a functional block diagram schematically showing the function of CPU 111 provided in MFP 100, together with data stored in HDD 116. Referring to FIG. 9, HDD 116 stores a temporary record 79. Temporary record 79 at least includes user identification information and biometric information, and is stored in HDD 116 by a registration portion 71, which will be described later.

CPU 111 includes: a fingerprint image accepting portion 51 to accept a fingerprint image; an identification information accepting portion 61 to accept user identification information; an extracting portion 53 to extract a temporary record stored in HDD 116; a requesting portion 55 to transmit an authentication request to authentication server 200; an authentication result receiving portion 63 to receive an authentication result from authentication server 200; a permission portion 65 to permit login based on the authentication result; a registration portion 71 to store the temporary record in HDD 116; a deleting portion 73 to delete one of the temporary records; and an initialization portion 75 to initialize the temporary records.

Fingerprint image accepting portion 51 accepts the fingerprint image of the user of MFP 100. Fingerprint image accepting portion 51 displays an authentication screen on display portion 114 to prompt fingerprint reading of the user. When fingerprint reading portion 121 reads the fingerprint and outputs the fingerprint image, fingerprint image accepting portion 51 accepts the fingerprint image. Fingerprint image accepting portion 51 outputs the fingerprint image to extracting portion 53.

FIG. 10 is a plan view showing an example of an operation panel on which an authentication screen is displayed. Referring to FIG. 10, operation panel 9 includes display portion 114, operating portion 115, and a read surface 121A of fingerprint reading portion 121. Operating portion 115 includes a ten key pad 115A, a start key 115B for designating fingerprint reading, and a clear key 115C for canceling the input content. Display portion 114 displays the authentication screen. The authentication screen includes a message reading: “LOGIN—Please have your biometrics scanned”.

When the user depresses start key 115B, fingerprint reading portion 121 is activated. When the user presses the ball of the finger onto read surface 121A of fingerprint reading portion 121, the fingerprint on the ball of the finger is read by fingerprint reading portion 121.

Returning to FIG. 9, extracting portion 53 extracts one of temporary records 79 stored in HDD 116 that includes the fingerprint image matching the fingerprint image input by fingerprint image accepting portion 51, as a target record. Specifically, extracting portion 53 reads one of temporary records 79 stored in HDD 116, and compares the fingerprint image included in the read temporary record 79 with the fingerprint image input by fingerprint image accepting portion 51, and if they match, it extracts the relevant temporary record 79 as the target record. If they do not match, extracting portion 53 reads a next temporary record 79 and makes comparison. Extracting portion 53 repeats the comparison until there is a match or until every temporary record 79 stored in HDD 116 is read and compared. When extracting portion 53 succeeded in extracting temporary record 79 including the fingerprint image matching the fingerprint image input by fingerprint image accepting portion 51 as the target record, it outputs the target record to requesting portion 55. If it failed to extract the target record, it outputs an error signal indicating that there is no target record and the fingerprint image input from fingerprint image accepting portion 51, to requesting portion 55.

Requesting portion 55 includes a first requesting portion 57 and a second requesting portion 59. First requesting portion 57, in receipt of the target record from extracting portion 53, transmits to authentication server 200 an authentication request including the user identification information included in the target record and the biometric information (fingerprint image).

Second requesting portion 59, in receipt of the error signal from extracting portion 53, requests user identification information from identification information accepting portion 61. In response to the request from second requesting portion 59, identification information accepting portion 61 displays an identification information input screen on display portion 114 to prompt the user to input user identification information.

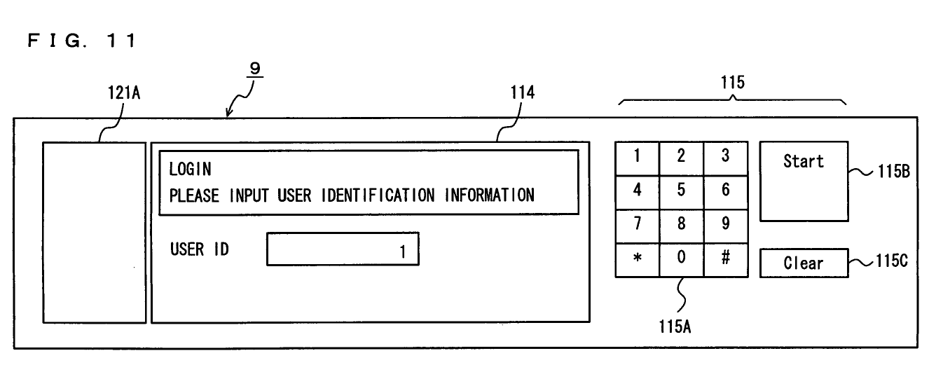

FIG. 11 is a plan view showing an example of the operation panel on which an identification information input screen is displayed. Referring to FIG. 11, the identification information input screen includes a message reading: “LOGIN—Please input user identification information”, and an area for inputting the user identification information. Herein, the user identification information is a user ID assigned to the user.

Returning to FIG. 9, when the user inputs the user identification information using ten key pad 115A, identification information accepting portion 61 accepts the user identification information from operating portion 115, and outputs the accepted user identification information to second requesting portion 59.

Second requesting portion 59, in receipt of the user identification information from identification information accepting portion 61, outputs an authentication request including the relevant user identification information and the fingerprint image input together with the error signal from extracting portion 53 to authentication server 200, and also outputs the user identification information and the fingerprint image to registration portion 71.

Registration portion 71 generates a temporary record with the user identification information and the fingerprint image input from second requesting portion 59, and stores the same in HDD 116. Accordingly, temporary record 79 is stored in HDD 116. Registration portion 71 may generate and store the temporary record in HDD 116 when the user identification information and the fingerprint image are input from second requesting portion 59, i.e., when the user identification information was accepted by identification information accepting portion 61. Alternatively, registration portion 71 may generate and store the temporary record in HDD 116 after an authentication result is received by authentication result receiving portion 63, which will be described later.

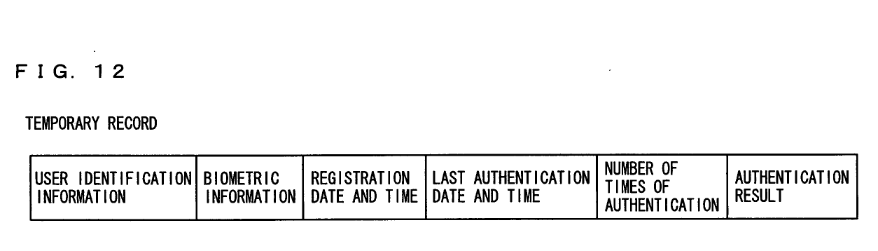

FIG. 12 shows an example of the format of the temporary record. Referring to FIG. 12, the temporary record includes user identification information, biometric information, registration date and time, last authentication date and time, the number of times of authentication, and an authentication result. The registration date and time refers to the date and time when the temporary record was stored in HDD 116. The last authentication date and time refers to the date and time when the authentication was lastly performed based on this temporary record. The number of times of authentication refers to the number of times of authentication performed after the temporary record was stored in HDD 116. The authentication result indicates whether the authentication based on this temporary record was successful. It is noted that the temporary record may include at least the user identification information and the biometric information.

Returning to FIG. 9, registration portion 71 generates a temporary record having the user identification information and the fingerprint image input from second requesting portion 59 set for the user identification information and the fingerprint image, respectively, the current time set for the registration date and time, and a blank set for each of the last authentication date and time, the number of times of authentication, and the authentication result. It stores the generated temporary record in HDD 116. The number of temporary records stored in HDD 116 has its upper limit set in advance. Upon storing a newly generated temporary record in HDD 116, registration portion 71 determines whether the number of temporary records 79 already stored in HDD 116 is equal to the upper limit value. If so, registration portion 71 requests deleting portion 73 to delete one temporary record.

Deleting portion 73, in response to the request from registration portion 71, deletes one of the temporary records 79 stored in HDD 116. Deleting portion 73 determines one temporary record to be deleted from among temporary records 79 stored in HDD 116. The temporary record to be deleted can be determined by one of the following conditions:
(1) The temporary record having the oldest registration date and time. It is highly probable that the user corresponding to the temporary record stored earliest no longer uses MFP 100, and there is only a small probability that he/she will log in MFP 100 next.
(2) The temporary record having the smallest number of times of authentication. There is only a small probability that the user who uses MFP 100 less frequently will log in MFP 100 next.
(3) The temporary record having the oldest date and time of last authentication. There is only a small probability that the user who used MFP 100 earliest will use MFP 100 next.
(4) The temporary record with which authentication by authentication server 200 failed. Even if authentication is attempted using the temporary record with which authentication by authentication server 200 once failed, the authentication will very likely fail again.
(5) The temporary record including the user identification information the same as the one included in the temporary record to be newly registered. Storing the latest fingerprint image will improve the accuracy of fingerprint authentication.

Further, it may also be possible to delete an arbitrary one of the plurality of temporary records 79 stored in HDD 116, or one selected by the user may be deleted therefrom.

Although the temporary record to be deleted may be determined by any of (1) through (5) above, if it is not possible to determine one temporary record using one of those conditions, two or more of them may be combined as appropriate.

In response to first requesting portion 57 or second requesting portion 59 transmitting the authentication request, data communication control portion 117 receives an authentication result from authentication server 200. The authentication result received by data communication control portion 117 is input to authentication result receiving portion 63. Authentication result receiving portion 63 outputs the authentication result received from authentication server 20 to permission portion 65.

Permission portion 65 permits the user login when the authentication result indicates authentication success, whereas permission portion 65 does not permit the user login when the authentication result indicates authentication failure. Permission portion 65 updates the last authentication date and time of the temporary record used for the authentication to the current date and time. The temporary record used for the authentication is the one extracted by extracting portion 53, or, when extracting portion 53 failed to extract the temporary record, the one generated by registration portion 71. Further, when the authentication result indicates authentication success, permission portion 65 increments the number of times of authentication of temporary record 79 used for authentication by 1. When the authentication result indicates authentication failure, permission portion 65 sets the authentication result of temporary record 79 used for authentication to authentication failure.

Initialization portion 75 initializes temporary records 79 stored in HDD 116 at a predetermined timing. Specifically, it deletes all the temporary records 79 stored in HDD 116. The predetermined timing may be, for example, when an instruction to turn off the power of MFP 100 is input, immediately after power is on, or at a predetermined date and time. The predetermined date and time may be, for example, the first day or the last day of week, month, term, or year, or the like. When initialization portion 75 initializes temporary records 79 stored in HDD 116, the user who is trying to log in thereafter will need to input user identification information. However, since the temporary records are all deleted each time of initialization, the time required for extracting portion 53 to extract temporary record 79 is shortened, and the accuracy of extraction is improved. Further, it is possible to prevent the number of temporary records from increasing too much. Furthermore, since unused temporary records 79 are deleted, it is possible to prevent the undesirable situation that unnecessary temporary records 79 are maintained consistently

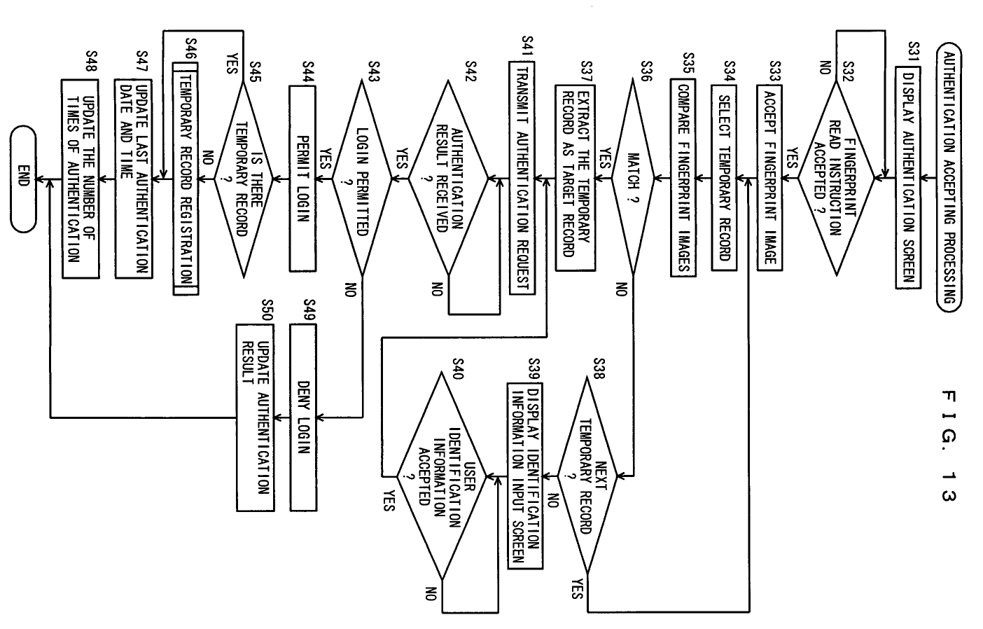

FIG. 13 is a flowchart illustrating an example of the flow of authentication accepting processing executed in the MFP. The authentication accepting processing is carried out by CPU 111 provided in MFP 100 as CPU 111 executes the authentication program stored in ROM 113. Referring to FIG. 13, CPU 111 displays the authentication screen, shown in FIG. 10, on display portion 114 (step S31).

Next, in step S32, it is determined whether a fingerprint read instruction to cause fingerprint reading has been accepted. Specifically, it is determined whether start key 115B in operating portion 115 has been depressed to cause fingerprint reading portion 121 to read the fingerprint. CPU 111 is in a standby mode until the fingerprint read instruction is accepted (NO in step S32), and once the fingerprint read instruction is accepted, the process proceeds to step S33.

In step S33, the fingerprint image output from fingerprint reading portion 121 is accepted. The fingerprint image is the image of the fingerprint of the user who operates MFP 100. One temporary record is then selected from among temporary records 79 stores in HDD 116 (step S34). Next, comparison is made between the fingerprint image accepted in step S33 and the fingerprint image included in the temporary record selected in step S34 (step S35). If they match (YES in step S36), the process proceeds to step S37. If they do not match (NO in step S36), the process proceeds to step S38. Herein, it is determined that there is a match not only in the case where they match completely but also in the case where they are similar enough to be determined that they are of the fingerprint of a same person. The degree of similarity may be determined in advance. In step S37, the temporary record selected in step S34, i.e., temporary record 79 including the fingerprint image matching the fingerprint image accepted in step S33 is extracted as a target record. The process then proceeds to step S41.

In step S38, it is determined whether there is another temporary record yet to be selected. If so, the process returns to step S34 to select the unselected one of temporary records 79 stored in HDD 116. If there is not any unselected temporary record, the process proceeds to step S39.

In step S39, the identification information input screen, shown in FIG. 11, is displayed on display portion 114. CPU 111 is in a standby mode until user identification information is accepted (NO in step S40), and once the user identification information is accepted, the process proceeds to step S41.

In step S41, CPU 111 transmits an authentication request including the user identification information and the fingerprint image to authentication server 200. When the process of step S37 is executed, i.e., when the temporary record including the fingerprint image matching the one accepted in step S33 is stored in HDD 116, the user identification information included in the authentication request is the one included in the relevant temporary record (target record), and the fingerprint image included in the authentication request is the one accepted in step S33. It may also be possible to transmit the fingerprint image included in the target record.

When the process of step S37 is not executed, i.e., when the temporary record including the fingerprint image matching the one accepted in step S33 is not stored in HDD 116, the user identification information included in the authentication request is the one input by the user via operating portion 115 in step S40, and the fingerprint image included in the authentication request is the one accepted in step S33.

CPU 111 is in a standby mode until an authentication result is received from authentication server 200 (NO in step S42), and once the authentication request is received (YES in step S42), the process proceeds to step S43. In step S43, it is determined whether the authentication result indicates that login is permitted. If so, the process proceeds to step S44; otherwise, the process proceeds to step S49.

In step S44, the user's login is permitted, and the process proceeds to step S45. In step S45, it is determined whether a temporary record for the user for whom login was permitted is stored in HDD 116. In other words, it is determined whether there is a temporary record that includes the user identification information included in the authentication request transmitted in step S41. If there is such a temporary record, the process proceeds to step S47; otherwise, the process proceeds to step S46.

It is noted that, in the case where step S40 is executed and the temporary record including the user identification information accepted in step S40 is already stored in HDD 116, the temporary record stored in HDD 116 is deleted, and the process proceeds to step S46. This is because it has been determined in the comparison in step S35 that the fingerprint image included in the deleted temporary record does not match the fingerprint image obtained by reading the fingerprint of the user in step S33. Registering a new temporary record including the newly read fingerprint image improves the accuracy of comparison of the fingerprint images.

In step S46, temporary record registration processing is carried out, and the process proceeds to step S47. The temporary record registration processing, which will be described later, is the processing of generating a new temporary record including the user identification information input by the user of MFP 100 and the fingerprint image obtained by reading the fingerprint of the relevant user and accepted in step S33, and storing the generated temporary record in HDD 116.

In step S47, the last authentication date and time of the temporary record is updated to the current date and time. The number of times of authentication of the temporary record is incremented by 1 (step S48), and the process is terminated. The temporary record for which the last authentication date and time and the number of times of authentication are being undated is the one of temporary records 79 stored in HDD 116 that corresponds to the user for whom login was permitted, or it is the newly registered temporary record when the temporary record registration processing is carried out in step S46.

Meanwhile, in step S49, the user's login is not permitted, and the process proceeds to step S50. Specifically, a message indicating that login is not permitted is displayed on display portion 114, and processing is not executed in response to the operation input thereafter. In step S50, the value in the field of the authentication result of the temporary record is updated to the value indicating authentication failure.

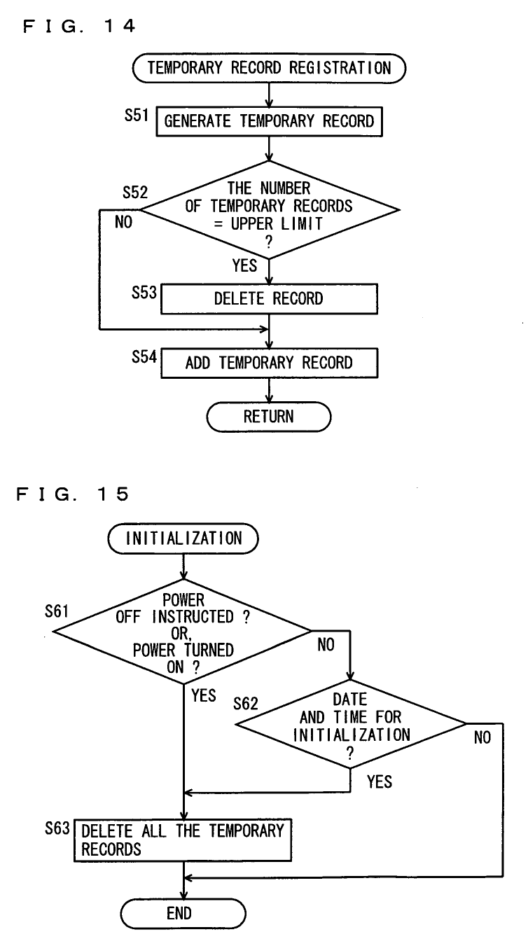

FIG. 14 is a flowchart illustrating an example of the flow of temporary record registration processing. The temporary record registration processing is the processing executed in step S46 in FIG. 13. Referring to FIG. 14, a new temporary record is generated (step S51). Specifically, the new temporary record is generated by setting the fingerprint image accepted from fingerprint reading portion 121 in step S33 of FIG. 13 in the field of fingerprint image, setting the user identification information accepted in step S40 in the field of user identification information, and setting the current date and time in the field of registration date and time. The fields of last authentication date and time, the number of times of authentication, and authentication result remain blank. The fingerprint image accepted from fingerprint reading portion 121 in step S33 and the user identification information accepted in step S40 are the fingerprint image and the user identification information of the user operating MFP 100.

In step S52, it is determined whether the total number of temporary records 79 stored in HDD 116 is equal to a predetermined upper limit value. If so, the process proceeds to step S53; otherwise, the process proceeds to step S54. In step S53, one temporary record is deleted from among temporary records 79 of the number equal to the upper limit value, stored in HDD 116. The temporary record to be deleted may be, for example, (1) the temporary record having the oldest registration date and time, (2) the temporary record having the smallest number of times of authentication, (3) the temporary record having the oldest date and time of last authentication, or (4) the temporary record with which authentication by authentication server 200 had failed. It may also be possible to delete an arbitrary one of temporary records 79 of the number equal to the upper limit value stored in HDD 116, or the user may select the one to be deleted.

In step S54, the temporary record generated in step S51 is stored in HDD 116, and the process returns to the authentication accepting processing.

FIG. 15 is a flowchart illustrating an example of the flow of initialization processing. The initialization processing is executed by CPU 111 of MFP 100 as CPU 111 executes the authentication program. Referring to FIG. 15, CPU 111 determines whether an instruction to turn off the power of MFP 100 was accepted, or whether the power has been turned on (step S61). When the instruction to turn off the power is accepted, or the power is turned on, the process proceeds to step S63; otherwise, the process proceeds to step S62. In step S62, it is determined whether the current date and time corresponds to the predetermined date and time for initialization. If so, the process proceeds to step S63; otherwise, the process is terminated. In step S63, temporary records 79 stored in HDD 116 are all deleted.

Since all the temporary records 79 stored in HDD 116 are deleted, the user needs to input user identification information to log in MFP 100 thereafter. However, once the user identification information is input, temporary record 79 is stored in HDD 116, and thus, it is only necessary to cause fingerprint reading portion 121 to read the fingerprint to log in after the temporary record is stored. When the initialization processing is carried out, the number of objects (fingerprint images included in temporary records 79) to be compared with the fingerprint image obtained by reading the fingerprint of the user who is trying to log in is reduced, which shortens the time required for the fingerprint image comparison processing. Correspondingly, the threshold for use in determination as to whether the two fingerprint images match or not can be set higher, whereby the accuracy of the match determination is increased.

While the fingerprint image has been used as an example of the biometric information in the present embodiment, not limited thereto, other biometric information such as vein pattern, iris, voice print or the like may also be used for authentication. In such a case, fingerprint reading portion 121 and fingerprint reader 208 are replaced with readers for inputting the relevant biometric information, and they are mounted to MFP 100 and authentication server 200.

As described above, MFP 100 according to the present embodiment stores temporary records 79 including the users' biometric information and the user identification information in HDD 116, and when a fingerprint image is accepted, extracts a target record from the stored temporary records that includes the fingerprint image matching the accepted fingerprint image. When the target record is extracted, it transmits the authentication request, including the user identification information included in the target record and the biometric information, to the authentication server, and permits the user login based on the authentication result received from the authentication server. This means that the user only needs to conduct an operation to have his/her fingerprint read, which simplifies the operation. Further, in authentication server 200, comparison of the biometric information needs to be conducted only once, which decreases the probability of erroneous authentication and also shortens the time required for the authentication.

In the case where the target record is not extracted from temporary records 79 stored in HDD 116, MFP 100 requests an input of the user identification information, accepts the same, and transmits the authentication request including the accepted user identification information and the biometric information to the authentication server. As such, even the user for whom the temporary record has not been stored can be authenticated by the authentication server. Accordingly, the users allowed to log in MFP 100 do not have to be registered in MFP 100; they are only needed to be registered in authentication server 200. This simplifies management of registration records 91 used for authentication.

Further, when the user identification information is accepted, or when the authentication result is received from authentication server 200 when the target record is not extracted, a new temporary record including the user identification information and the fingerprint image is generated and stored in HDD 116. Once the pair of the user identification information and the biometric information is stored in HDD 116, only the operation to have the fingerprint read is required. This reduces the number of times of operations required for the login.

When the number of temporary records will exceed a predetermined upper limit, one of temporary records 79 of the number equal to the upper limit value stored in HDD 116 is deleted. Since the number of temporary records 79 stored in HDD 116 is restricted, the number of times of comparison of the fingerprint images is restricted. This prevents prolongation of the time required for pattern matching of the fingerprint images, and also improves the accuracy of the pattern matching.

Furthermore, the temporary records are all deleted when an instruction to turn off the power is accepted, or the power is turned on, or a predetermined date and time has arrived. This prevents the number of temporary records from increasing too much. Further, unused temporary records 79 are deleted, which also prevents the undesirable situation that unnecessary temporary records are maintained in HDD 116 consistently.

While authentication system 1 has been described in the above embodiment, the present invention may of course be understood as an authentication method or an authentication program that causes a computer to execute the processing illustrated in FIGS. 7, 8, and 13-15.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus, comprising:
a storage portion to store a temporary record including biometric information of a user and user identification information;
a biometric information accepting portion to accept biometric information of a user;
an extracting portion to extract a target record including biometric information matching said accepted biometric information from among said temporary records stored in said storage portion;
a requesting portion, when said target record is extracted by said extracting portion, to transmit an authentication request to an authentication server, the authentication request including said user identification information included in said target record and said biometric information; and
a permission portion to permit login of the user having said biometric information accepted by said biometric information accepting portion based on an authentication result received from said authentication server in response to transmission of said authentication request by said requesting portion.

2. The information processing apparatus according to claim 1, further comprising an identification information accepting portion, when said target record is not extracted, to request an input of user identification information and accept the user identification information, wherein
when said target record is not extracted, said requesting portion transmits an authentication request including said user identification information accepted by said identification information accepting portion and said biometric information accepted by said biometric information accepting portion to said authentication server.

3. The information processing apparatus according to claim 2, further comprising a registration portion, when said user identification information is accepted by said identification information accepting portion, or when an authentication result is received from said authentication server when said target record is not extracted, to generate a new temporary record including said user identification information accepted by said identification information accepting portion and said biometric information accepted by said biometric information accepting portion, and store said new temporary record in said storage portion.

4. The information processing apparatus according to claim 3, further comprising a deleting portion to delete one of said temporary records stored in said storage portion when said new temporary record is generated by said registration portion and when the number of said temporary records stored in said storage portion at this time is equal to a predetermined upper limit value.

5. The information processing apparatus according to claim 4, wherein said deleting portion deletes one of said temporary records stored in said storage portion that was stored earliest.

6. The information processing apparatus according to claim 4, wherein said deleting portion deletes one of said temporary records stored in said storage portion that has a smallest number of times of authentication.

7. The information processing apparatus according to claim 4, wherein said deleting portion deletes one of said temporary records stored in said storage portion that was extracted earliest by said extracting portion.

8. The information processing apparatus according to claim 4, wherein said deleting portion deletes one of said temporary records stored in said storage portion with which authentication by said authentication server failed.

9. The information processing apparatus according to claim 4, wherein said deleting portion deletes one of said temporary records stored in said storage portion that includes the user identification information identical to said user identification information included in said new temporary record.

10. The information processing apparatus according to claim 1, further comprising an initialization portion to delete all of said temporary records stored in said storage portion.

11. The information processing apparatus according to claim 10, wherein said initialization portion deletes all of said temporary records stored in said storage portion when power is turned off, or when a predetermined date and time has arrived.

12. An information processing apparatus, comprising:
a biometric information accepting portion to accept biometric information of a user;
an identification information accepting portion to accept user identification information;
a requesting portion to transmit an authentication request to an authentication server, the authentication request including said accepted biometric information and said accepted user identification information; and
a registration portion to register a temporary record including said accepted biometric information and said accepted user identification information based on an authentication result received from said authentication server in response to transmission of the authentication request by said requesting portion.

13. The information processing apparatus according to claim 12, further comprising an extracting portion, when biometric information is accepted by said biometric information accepting portion, to extract a target record including biometric information matching said biometric information from among said temporary records, wherein
said requesting portion transmits an authentication request, including said biometric information and said user identification information included in said extracted target record, to said authentication server.

14. The information processing apparatus according to claim 13, further comprising a permission portion to permit login of the user having said biometric information accepted by said biometric information accepting portion based on an authentication result received from said authentication server in response to transmission of the authentication request by said requesting portion.

15. An authentication system having a plurality of information processing apparatuses and an authentication server,
each of said plurality of information processing apparatuses comprising:
a storage portion to store a temporary record including biometric information of a user and user identification information;
a biometric information accepting portion to accept biometric information of a user;
an extracting portion to extract a target record including biometric information matching said accepted biometric information from among said temporary records stored in said storage portion;
a requesting portion, when said target record is extracted by said extracting portion, to transmit an authentication request to an authentication server, the authentication request including said user identification information included in said target record and said biometric information; and
a permission portion to permit login of the user having said biometric information accepted by said biometric information accepting portion based on an authentication result received from said authentication server in response to transmission of said authentication request by said requesting portion; and
said authentication server comprising:
a registration record storage portion to store a plurality of registration records each including biometric information of a user and user identification information;
an authentication record extracting portion, in response to reception of said authentication request from one of said plurality of information processing apparatuses, to extract a record for authentication including user identification information identical to said user identification information included in said received authentication request from among said plurality of registration records stored in said registration record storage portion;
a comparison portion to compare biometric information included in said record for authentication with said biometric information included in said authentication request; and
an authentication result transmitting portion to transmit a comparison result by said comparison portion to said one of said plurality of information processing apparatus that transmitted said authentication request.

16. An authentication method, comprising the steps of:
storing a temporary record including biometric information of a user and user identification information;
accepting biometric information of a user;
extracting a target record including biometric information matching said accepted biometric information from among said temporary records stored;
when said target record is extracted in said step of extracting the target record, transmitting an authentication request to an authentication server, the authentication request including said user identification information included in said target record and said biometric information; and
permitting login of the user having said biometric information accepted in said step of accepting the biometric information based on an authentication result received from said authentication server in response to transmission of said authentication request.

17. An authentication method executed by a plurality of information processing apparatuses and an authentication server,
causing each of said plurality of information processing apparatuses to execute the steps of:
storing a temporary record including biometric information of a user and user identification information;
accepting biometric information of a user;
extracting a target record including biometric information matching said accepted biometric information from among said stored temporary records;
when said target record is extracted, transmitting an authentication request to an authentication server, the authentication request including said user identification information included in said target record and said biometric information; and
permitting login of the user having said biometric information accepted in said step of accepting the biometric information based on an authentication result received from said authentication server in response to transmission of said authentication request; and
causing said authentication server to execute the steps of:
storing a plurality of registration records each including biometric information of a user and user identification information;
in response to reception of said authentication request from one of said plurality of information processing apparatuses, extracting a record for authentication including user identification information identical to said user identification information included in said received authentication request from among said plurality of registration records stored;
comparing biometric information included in said record for authentication with said biometric information included in said authentication request; and
transmitting a comparison result in said comparing step to said one of said plurality of information processing apparatuses that transmitted said authentication request.

18. An authentication program embodied on a computer readable medium for causing a computer to execute processing comprising the steps of
storing a temporary record including biometric information of a user and user identification information;
accepting biometric information of a user;
extracting a target record including biometric information matching said accepted biometric information from among said temporary records stored;
when said target record is extracted in said step of extracting the target record, transmitting an authentication request to an authentication server, the authentication request including said user identification information included in said target record and said biometric information; and
permitting login of the user having said biometric information accepted in said step of accepting the biometric information based on an authentication result received from said authentication server in response to transmission of said authentication request.
